(19) United States
(12) Patent Application Publication
(10) Pub. No.: US 2007/0277607 A1
(43) Pub. Date: Dec. 6, 2007

(54) Semiconductor acceleration sensor

(75) Inventor: Yoshihiko Ino, Miyazaki (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/785,336

(22) Filed: Apr. 17, 2007

(30) Foreign Application Priority Data
May 31, 2006 (JP) 2006-151022

(51) Int. Cl. G01P 15/02

(52) U.S. Cl. 73/514.16

(57) ABSTRACT

A semiconductor acceleration sensor of the invention comprises: a sensor chip having a pad formation surface around whose edge are formed a plurality of pads, and in which a rectangular frame shaped protrusion is formed on an area of the pad formation surface on a center side of the pads; and a control chip which has a terminal formation surface on which connection terminals are formed, and has a planar shape such that the pad of the sensor chip is visible from the terminal formation surface side. Moreover, the opposite surface of the control chip to the terminal formation surface is bonded to the frame shaped protrusion of the sensor chip.

### CROSS REFERENCE TO RELATED APPLICATION

This application claims the priority of Application No. 2006-151022, filed May 31, 2006 in Japan, the subject matter of which is incorporated herein by reference.

### TECHNICAL FIELD OF THE INVENTION

The present invention relates to a semiconductor acceleration sensor for installation in transportation equipment such as vehicles and aircraft which is used to measure acceleration and detect collisions and the like.

### BACKGROUND OF THE INVENTION

Conventional semiconductor acceleration sensors comprise a control chip that has a terminal formation surface, around the edge of which are formed a plurality of connection terminals. Such semiconductor acceleration sensors also comprise a pad formation surface on which a plurality of pads and movable sections are formed, and a capacitance type sensor chip on which three projections are formed on the opposite surface of the sensor chip to the pad formation surface. The projections of the capacitance type sensor chip contact the terminal formation surface of the control chip in a manner that allows the connection terminals to remain visible. Furthermore, the control chip and the capacitance type sensor chip are bonded together by a film adhesive to form a laminate chip. The opposite surface of the control chip to the terminal formation surface is bonded by an adhesive to the base of a bottomed case that has a central stage section. Wire is used to provide an electrical connection between the internal terminals provided on the central stage section and the connection terminals of the control chip, and between the connection terminals of the control chip and the pads of the sensor chip. Furthermore, the opening in the case is sealed by a cover, thereby achieving a packaged semiconductor acceleration sensor with a small form factor (see Patent document 1, for example).

[Patent document 1] Japanese Unexamined Patent Publication No. 2002-323514 (primarily page 3, paragraphs 0020 to 0042, and FIG. 1, FIG. 2)

### DISCLOSURE OF INVENTION

However, with the conventional technology described above, because a laminate chip is formed by laminating the sensor chip onto the control chip, the connection terminals on the terminal formation surface of the control chip cannot be located in an area covered by the sensor chip, which creates difficulty when attempting to miniaturize control chips that have a larger number of connection terminals than there are pads on the sensor chip, and presents a problem in that a larger package size is required.

Furthermore, because the opposite side of the sensor chip to the pad formation surface is bonded to the control chip, the section that supports the movable sections used to detect variations in capacitance that indicate the presence of acceleration is insufficiently rigid, which can lower the measurement sensitivity for acceleration or cause temperature drift due to bending or the like of the support section that occurs when the temperature within the package varies.

The same applies for sensor chips that detect acceleration using piezo elements.

### OBJECTS OF THE INVENTION

The present invention takes the above circumstances into consideration, with an object of providing ways to miniaturize a semiconductor acceleration sensor incorporating a laminate chip, and improve the rigidity of the support section of the sensor chip.

Additional objects, advantages and novel features of the present invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

A semiconductor acceleration sensor according to the present invention comprises: a sensor chip having a pad formation surface around whose edge are formed a plurality of pads, and in which a rectangular frame shaped protrusion is formed on an area of the pad formation surface on a center side of the pads; and a control chip which has a terminal formation surface on which connection terminals are formed, and has a planar shape such that the pad of the sensor chip is visible from the terminal formation surface side. The opposite surface of the control chip to the terminal formation surface is bonded to the frame shaped protrusion of the sensor chip.

As a result, the rigidity of the support section that supports the flexible sections or other movable parts of the sensor chip can be enhanced, and the acceleration applied to the sensor chip can be measured with greater sensitivity. Furthermore, the sensor chip and the control chip can together occupy the same area as the planar shape of the sensor chip, which provides the effect of allowing the package size of the semiconductor acceleration sensor to be miniaturized.

### BRIEF DESCRIPTION OF THE DRAWINGS

FIG. 1 is an explanatory diagram showing the top surface of a semiconductor acceleration sensor according to a first embodiment.

FIG. 2 is an explanatory diagram showing a cross-section of the semiconductor acceleration sensor according to the first embodiment.

FIG. 3 is an explanatory diagram showing the top surface of a sensor chip according to the first embodiment.

FIG. 4 is an explanatory diagram showing a cross-section of the sensor chip according to the first embodiment.

FIG. 5 is an explanatory diagram showing the top surface of a semiconductor acceleration sensor according to a second embodiment.

FIG. 6 is an explanatory diagram showing a cross-section of the semiconductor acceleration sensor according to the second embodiment.

FIG. 7 is an explanatory diagram showing the top surface of a semiconductor acceleration sensor according to a third embodiment.

FIG. 8 is an explanatory diagram showing a cross-section of the semiconductor acceleration sensor according to the third embodiment.

FIG. 9 is an explanatory diagram showing the top surface of a semiconductor acceleration sensor according to a fourth embodiment.

FIG. 10 is an explanatory diagram showing a cross-section of the semiconductor acceleration sensor according to the fourth embodiment.

FIG. 11 is an explanatory diagram showing the top surface of a semiconductor acceleration sensor according to a fifth embodiment.

FIG. 12 is an explanatory diagram showing a cross-section of the semiconductor acceleration sensor according to the fifth embodiment.

### DESCRIPTION OF THE REFERENCE SYMBOLS

1 Semiconductor acceleration sensor
2 Case
2b, 9b, 35b Rear surface
3 Central stage section
3a Stepped surface
4 Cavity
5 Plug
6 External terminal
7 Internal terminal
9 Sensor chip
9a Pad formation surface
10 Piezo element
11 Support section
12 Flexible section
13 Weight section
15 Pad
18 Frame shaped protrusion
20 Control chip
20a Terminal formation surface
21 Connection terminal
22 Adhesive film
23 Wire
25 Adhesive layer
28 Bonding member
31 Through hole
35 Glass plate
36 Sealing layer
41 Notch
45 Adhesive

### DETAILED DISCLOSURE OF THE INVENTION

In the following detailed description of the preferred embodiments, reference is made to the accompanying drawings which form a part hereof, and in which is shown by way of illustration specific preferred embodiments in which the inventions may be practiced. These preferred embodiments are described in sufficient detail to enable those skilled in the art to practice the invention, and it is to be understood that other preferred embodiments may be utilized and that logical, mechanical and electrical changes may be made without departing from the spirit and scope of the present inventions. The following detailed description is, therefore, not to be taken in a limiting sense, and scope of the present inventions is defined only by the appended claims.

Embodiments of a semiconductor acceleration sensor according to the present invention are described below with reference to the drawings.

### EMBODIMENT 1

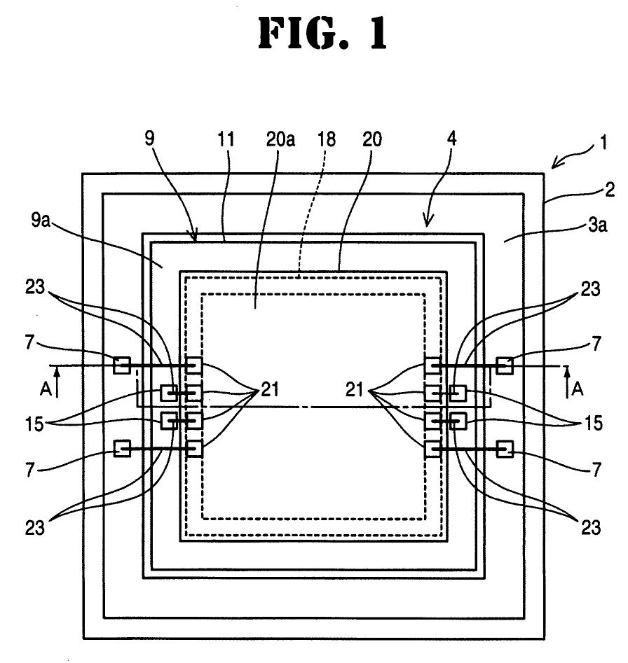

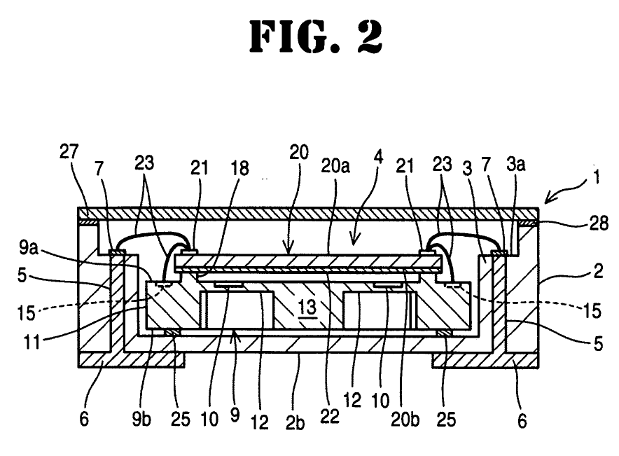

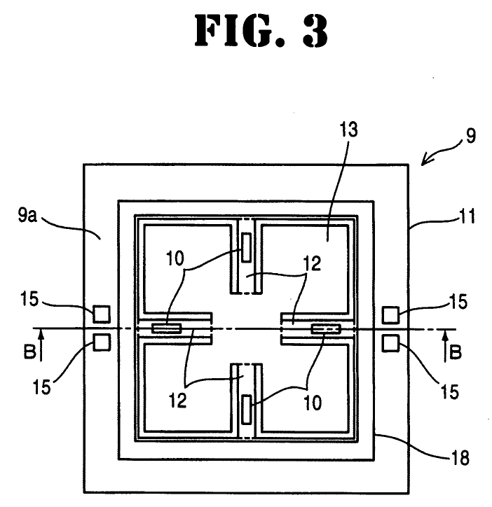

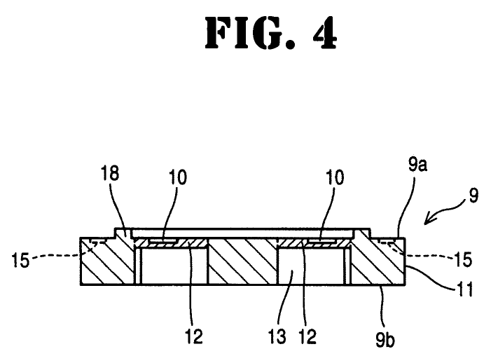

FIG. 1 is an explanatory diagram showing the top surface of a semiconductor acceleration sensor according to a first embodiment; FIG. 2 is an explanatory diagram showing a cross-section of the semiconductor acceleration sensor according to the first embodiment; FIG. 3 is an explanatory diagram showing the top surface of a sensor chip according to the first embodiment; and FIG. 4 is an explanatory diagram showing a cross-section of the sensor chip according to the first embodiment.

FIG. 1 shows a state in which the cover is removed, FIG. 2 shows a cross-section along the line A-A in FIG. 1, and FIG. 4 shows a cross-section along the line B-B in FIG. 3.

In FIG. 1 and FIG. 2, reference numeral 1 indicates a semiconductor acceleration sensor. Reference numeral 2 indicates a case, which is a box shaped member made of ceramic, for example, and comprising a cavity 4 housing a central stage section 3. On a stepped surface 3a of the central stage section 3, a plurality of internal terminals 7 are formed which by means of electrically conductive plugs 5 formed so as to pass through the central stage section 3 from the stepped surface 3a in the depth direction of the cavity 4, electrically connect to external terminals 6 formed on a back surface 2b of the case 2 which feed the signal to an external destination.

Reference numeral 9 indicates a sensor chip which, using piezo elements 10, outputs acceleration components across three mutually orthogonal axes consisting of an X axis, Y axis, and Z axis.

In FIG. 3 and FIG. 4, reference numeral 11 indicates a support section made of silicon (Si). The support 11 is a rectangular frame formed around the edge of the sensor chip 9 which houses a weight section 13 in a freely oscillating manner. The weight section 13 is suspended from flexible sections 12 which are formed from a thin layer of silicon and arranged in a cross formation.

Each of the flexible sections 12 is supported at one of the four sides of the support section 11. A piezo element 10 is formed on each flexible section 12. On the support section 11, on the same side as the surface where the piezo elements 10 are formed, pads 15 made of a conductive material such as aluminum (Al) are formed in a symmetrical arrangement with respect to the vertical in the figure. The surface on which the pads 15 are formed is referred to as a pad formation surface 9a of the sensor chip 9.

The piezo element 10 formed on each flexible section 12 is internally connected to a predetermined pad 15 on the support section 11. When acceleration is applied to the sensor chip 9, the weight section 13 oscillates. When this occurs, the flexible sections 12 deform, and the expansion and contraction of the piezo elements 10 is output from the pads 15 in the form of a pressure signal.

In the figures, reference numeral 18 indicates a frame shaped protrusion. The movable part is formed from the flexible sections 12 and the weight sections 13 suspended therefrom. The protrusion 18 is formed on the pad formation surface 9a of the sensor chip 9 so as to surround the periphery of the movable part. The protrusion 18 is a rectangular protrusion formed on the center side (inward side) of the pads 15.

In FIG. 1 and FIG. 2, reference numeral 20 indicates a control chip such as an LSI (Large Scale Integrated circuit). On one of the surfaces of the control chip 20, a plurality of connection terminals 21 are formed which each electrically connect to a predetermined part of the internal circuitry. The surface of the control chip 20 on which these connection terminals 21 are formed is referred to as the terminal formation surface 20a. The control chip 20 provides functionality that converts the pressure signal output from the sensor chip 9 to a voltage signal or the like and outputs the converted signal.

Furthermore, the control chip 20 has a flat rectangular shape (when viewed from the terminal formation surface 20a side, in other words, the shape shown in FIG. 1). The planar shape of the control chip 20 is smaller than a rectangular shape inscribed in the pads 15 around the edge of the sensor chip 9, but larger than the external shape of the frame shaped protrusion 18. The opposite surface of the control chip 20 to the terminal formation surface 20a (referred to as the rear surface 20b) is bonded to the top surface of the frame shaped protrusion 19 by means of an adhesive film 22, for example double sided adhesive tape. At this time, the pads 15 of the sensor chip 9 are visible from the terminal formation surface 20a side.

In addition, in the present embodiment the connection terminals 21 of the control chip 20 are formed such that when the control chip 20 is bonded on top of the sensor chip 9, the connection terminals 21 are positioned above the frame shaped protrusion 18.

Reference numeral 23 indicates wires, in this case thin metallic wires formed from a conductive material such as gold (Au). The wires 23 provide an electrical connection between the internal terminals 7 formed on the stepped surface 3a of the central stage section 3 of the case 2 and the connection terminals 21 of the control chip 20. The wires 23 also provide an electrical connection between the connection terminals 21 of the control chip 20 and the pads 15 of the sensor chip 9.

Reference numeral 25 indicates an adhesive layer, formed to a thickness of approximately 10 to 20 μm from an adhesive with relatively high elasticity. The adhesive layer 25 bonds the base of the cavity 4 of the case 2 to the opposite surface (referred to as the rear surface 9b of the sensor chip 9) of the support section 11 of the sensor chip 9 from the pad formation surface 9a.

Reference numeral 27 indicates a cover, which is a sheet-like member made of a thin sheet of a resin material or the like. The cover 27 is bonded to the top of the side panels of the case 2 by a bonding member 27 such as an adhesive or wax, and the space thus formed houses the laminate chip or the like formed by bonding the control chip 20 onto the sensor chip 9 while preventing dust and dirt from entering from outside.

The following describes a method of manufacturing a semiconductor acceleration sensor 1 with the configuration described above.

### (Step 1)

A sensor chip 9 is formed by processing a semiconductor wafer formed with a number of sensor chips 9 into individual chips. An adhesive film 22 is attached to the rear surface of a semiconductor wafer formed with a plurality of control chips 20, and the resulting product is processed into individual chips, thereby forming a control chip 20 comprising an adhesive film 22 on the rear surface 20b.

By insert molding or the like, the case 2 having external terminals 6 and internal terminals 7 formed on the central stage section 3 thereof is formed. The internal terminals 7 are electrically connected to the external terminals 6 via the plugs 5.

### (Step 2)

The rear surface 9b of the sensor chip 9 is affixed by an adhesive or the like to the central part of the base of the cavity 4 of the case 2. The sensor chip 9 is bonded to the base of the cavity 4 by the adhesive layer 25.

### (Step 3)

After bonding the sensor chip 9, the control chip 20 is positioned above and then affixed to the frame shaped protrusion 18 of the sensor chip 9 by means of the adhesive film 22. As a result, a laminate chip consisting of the control chip 20 bonded on top of the sensor chip 9 is formed.

(Step 4)

The rear surface 2b of the case 2 containing the laminate chip bonded to the base of the cavity 4 is placed on a bonding stage. A bonding tool is used to electrically connect the internal terminals 7 formed on the stepped surface 3a of the central stage section 3 of the case 2 to the connection terminals 21 of the control chip 20 by means of the wires 23. The bonding tool is also used to electrically connect the connection terminals 21 of the control chip 20 to the management center 15 of the sensor chip 9 by means of the wires 23.

(Step 5)

After the wire bonding process is completed, the cover 27 is bonded to the top surface of the side panels of the case 2 by a bonding member 28, forming a space between the cover 27 and the case 2 that seals in the laminate chip consisting of the control chip 20 bonded on top of the sensor chip 9.

In this manner the semiconductor acceleration sensor 1 of the present embodiment shown in FIG. 1 and FIG. 2 is manufactured. In this semiconductor acceleration sensor 1, because the frame shaped protrusion 15 formed on the pad formation surface 9a of the support section 11 of the sensor chip 9 is bonded to the rear surface 20b of the control chip 20 by means of an adhesive film 22, the rigidity of the support section 11 which supports movable parts such as the flexible sections 12 is enhanced. As a result, the acceleration applied to the sensor chip can be measured with greater sensitivity. Furthermore, bending or the like of the support section 11 that occurs with variation in the temperature within the package can be prevented, thereby suppressing the effect of temperature drift on the pressure signal of the sensor chip 9.

The size of the sensor chip 9 is the main factor influenced by such dynamic parameters as the mass of the weight section 13 relative to the flexibility of the flexible sections 12 as determined by their thickness, length, and width. Because the control chip 20, which is easy to miniaturize through high integration and the like, is laminated onto the sensor chip 9, the laminate chip consisting of the sensor chip 9 and the control chip 20 can occupy the same area as the planar shape of the sensor chip 9 alone. For this reason, the package size of the semiconductor acceleration sensor 1 can be reduced in comparison to a laminate chip consisting of a sensor chip bonded on top of a control chip. Furthermore, the connection terminals 21 of the control chip 20 which are more numerous than the pads 15 of the sensor chip 9 can be formed without being constrained by the configuration of the sensor chip 9, which facilitates further miniaturization and higher integration of the control chip 20.

In addition, in the wire bonding process, the control chip 20 which is bonded on top of the sensor chip 9 is miniaturized in such a manner that the pads 15 of the sensor chip 9 are visible from the terminal formation surface 20a side. Consequently, connections can easily be made between the pads 15 of the sensor chip 9 and the connection terminals 21 of the control chip 20 by means of the wires 23. Furthermore, because the connection terminals 21 of the control chip 20 are formed in positions above the frame shaped protrusion 18 of the sensor chip 9, deformation of the control chip 20 caused by impact during bonding of the wires 23 to the connection terminals 21 can be prevented, while also reducing the impact applied to the sensor chip 9.

As described above, in the present embodiment, a rectangular frame shaped protrusion is provided on the center side of the pads on the pad formation surface of the sensor chip having a plurality of pads formed around the edges, and the rear surface of a control chip having a planar shape that allows the pads of the sensor chip to be visible from the terminal formation surface side is bonded to this frame shaped protrusion. Consequently, the rigidity of the support section that supports the flexible sections and other movable parts of the sensor chip can be improved, and the acceleration applied to the sensor chip can be measured with greater sensitivity. Furthermore, the sensor chip and control chip can have the same installed area as determined by the planar shape of the sensor chip, allowing miniaturization of the package size of the semiconductor acceleration sensor.

Furthermore, by forming the connection terminals of the control chip above the frame shaped protrusion of the sensor chip, deformation of the control chip caused by impact during the process of bonding of the wires to the connection terminals can be prevented, while also reducing the impact applied to the sensor chip.

### EMBODIMENT 2

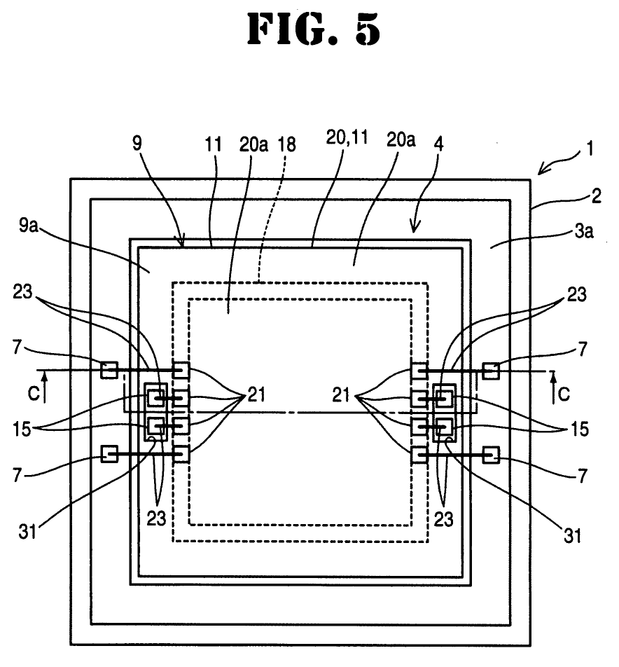

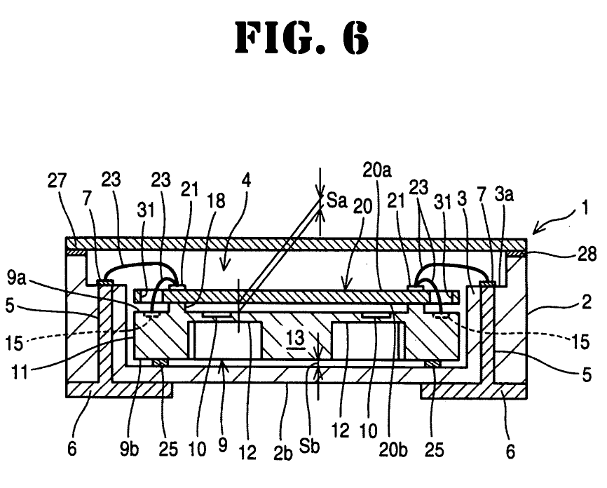

FIG. 5 is an explanatory diagram showing the top surface of a semiconductor acceleration sensor according to a second embodiment, and FIG. 6 is an explanatory diagram showing a cross-section of the semiconductor acceleration sensor according to the second embodiment.

FIG. 5 shows the semiconductor acceleration sensor with the cover removed, and FIG. 6 shows a cross-section along the line C-C in FIG. 5.

Moreover, those elements which are the same as in embodiment 1 are given the same reference numerals and description thereof is omitted.

The control chip 20 of the present embodiment, as shown in FIG. 5 and FIG. 6, has the same planar shape as the sensor chip 9. In the control chip 20, in the areas covering the pads 15 of the sensor chip 9, through holes 31 are formed so that the pads 15 are visible from the terminal formation surface 20a side.

Furthermore, the joining of the frame shaped protrusion 18 of the sensor chip 9 to the rear surface 20b of the control chip 20 is performed using vacuum pressure bonding.

In the present embodiment, the height of the frame shaped protrusion 18 from the pad formation surface 9a is set such that a gap Sa is formed between the top surface of the flexible sections 12 and the rear surface 20b of the control chip 20. The gap Sa is set to such a width that the flexible sections 12 cannot be damaged by excessive oscillation of the weight section 13, particularly oscillation in the vertical direction that causes excessive flexure of the flexible sections 12. The thickness of the adhesive layer 25 is set such that a similar gap Sb is formed between the bottom surface of the weight section 13 and the base of the cavity 4.

In the present embodiment, the thickness of the adhesive layer 25 and the height of the frame shaped protrusion are each set to approximately 10 to 20 μm.

The following describes a method of manufacturing a semiconductor acceleration sensor 1 with the configuration described above.

### (Step 1)

A semiconductor wafer is prepared formed with a plurality of control chips 20 in which through holes 31 are provided at the locations where the pads 15 of the sensor chip 9 are formed. Furthermore, a semiconductor wafer formed with a plurality of sensor chips 9 with frame shaped protrusions 18 is prepared. In the semiconductor wafer formed with the sensor chips 9, the pads 15 are aligned with the through holes 31. The frame shaped protrusions 18 of the semiconductor wafer formed with the sensor chips 9 are bonded to the rear surface of the semiconductor wafer formed with the control chips 20 by vacuum pressure bonding. The two joined semiconductor wafers are processed together into individual chips. As a result, a laminate chip is formed in which the frame shaped protrusion 19 of the sensor chip 9 is bonded to the rear surface 20b of the control chip 20 in which the through holes 31 are formed.

Next, a case 2 is formed in the same manner as in step 1 of embodiment 1.

### (Step 2)

In the same manner as in step 1 of embodiment 1, the rear surface 9b of the sensor chip 9 of the laminate chip is affixed to the center of the base of the cavity 4 of the case 2. Then, the laminate chip consisting of the control chip 20 bonded on top of the sensor chip 9 is bonded to the base of the cavity 4 by the adhesive layer 25.

### (Step 3)

In the same manner as in step 4 of embodiment 1, a wire bonder is used to electrically connect the internal terminals 7 to the connection terminals 21, and the connection terminals 21 to the pads 15, by means of the wires 23.

### (Step 4)

After the wire bonding process is completed, in the same manner as in step 5 of embodiment 1, the cover 27 is bonded to the case 2, forming a space that seals in the laminate chip consisting of the control chip 20 bonded on top of the sensor chip 9.

In this manner, the semiconductor acceleration sensor 1 of the present embodiment shown in FIG. 5 and FIG. 6 is manufactured. In this semiconductor acceleration sensor 1, the frame shaped protrusion 15 formed on the pad formation surface 9a of the support section 11 of the sensor chip 9 is bonded to the rear surface 20b of the control chip 20 by vacuum pressure bonding. Consequently, in the same manner as the first embodiment, the rigidity of the support section 11 of the sensor chip 9 is enhanced, yielding an improvement in measurement sensitivity and a reduction in temperature drift.

Furthermore, because the control chip 20 is laminated on top of a sensor chip 9 of similar size, in the same manner as embodiment 1, the laminate chip can occupy the same area as the planar shape of the sensor chip 9 alone, and the package size of the semiconductor acceleration sensor 1 can be reduced. This also facilitates even higher integration of control chips 20 that have a large number of connection terminals 21.

In addition, in the semiconductor wafer manufacturing process, because a semiconductor wafer formed with a plurality of control chips 20 comprising through holes 31 is bonded to a semiconductor wafer formed with a plurality of sensor chips 9 comprising pads 15 at positions corresponding to the through holes 31, electrical testing of the sensor chip 9 and the control chip 20 can be performed simultaneously, which simplifies the testing process during manufacture of the sensor chip 9 and the control chip 20. Furthermore, in the semiconductor wafer manufacturing process, laminate chips consisting of a control chip 20 comprising through holes 31 bonded on top of a sensor chip 9 can be formed in advance by processing the two joined semiconductor wafers together into individual chips, which simplifies the assembly process of the semiconductor acceleration sensor 1 and reduces the assembly cost.

In addition, in the semiconductor acceleration sensor 1 of the present embodiment, the height of the frame shaped protrusion 18 bonded to the rear surface 20b of the control chip 20 by vacuum pressure bonding, and the thickness of the adhesive layer 25 which bonds the rear surface 9b of the sensor chip 9 to the base of the cavity 4 form predetermined gaps Sa and Sb above and below the movable parts of the sensor chip 9 consisting of the weight section 13 and the flexible sections 12. Consequently, the degree of flexure of the flexible sections 12 can be restricted, and damage to the flexible section 12 during acceleration measurement can be prevented. Furthermore, because in the manufacturing process of the semiconductor wafer a laminate chip is formed in which the control chip 20 covers the flexible sections 12 of the sensor chip 9, the flexible sections 12 are protected from external forces resulting from collision with other parts during transportation of the laminate chip or installation into the case 2, and damage can be prevented.

In addition, in the wire bonding process described in step 3, because the control chip 20 of the present embodiment which is bonded on top of the sensor chip 9 is formed such that the pads 15 of the sensor chip 9 are visible from the terminal formation surface 20a side through the through holes 31, connections can be easily established between the pads 15 of the sensor chip 9 and the connection terminals 21 of the control chip 20 by means of the wire 23. Furthermore, in the same manner as in embodiment 1, the positioning of the connection terminals 21 of the control chip 20 above the frame shaped protrusion 18 of the sensor chip 9 has the effect of preventing deformation of the control chip 20 and reducing impact on the sensor chip 9.

As described above, in the present embodiment, in addition to realizing the same effects as the first embodiment, by forming through holes in the control chip through which the pads of the sensor chip are visible, the semiconductor wafer formed with the control chips can be bonded onto the semiconductor wafer formed with the sensor chips during the semiconductor wafer manufacturing process, and electrical testing of the sensor chips and control chips can be performed simultaneously, which simplifies the testing process during manufacture of the sensor chips and the control chips. Furthermore, a laminate chip that contains a control chip provided with through holes can be formed in advance in the semiconductor wafer manufacturing process, which simplifies the assembly process of the semiconductor acceleration sensor.

### EMBODIMENT 3

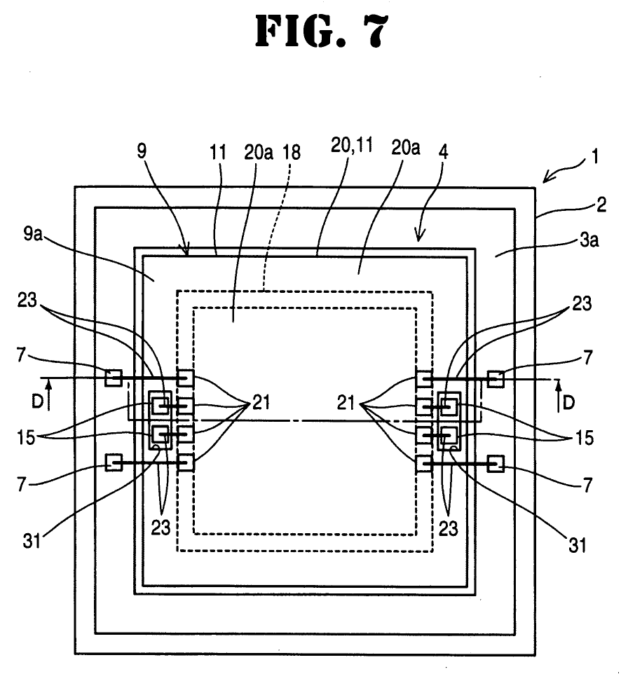

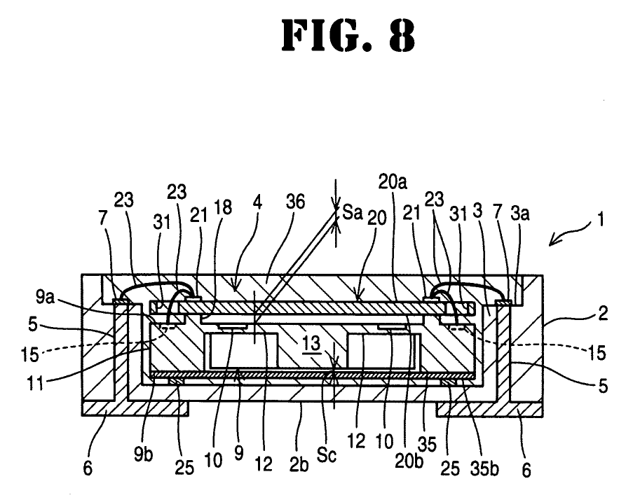

FIG. 7 is an explanatory diagram showing the top surface of a semiconductor acceleration sensor according to a third embodiment, and FIG. 8 is an explanatory diagram showing a cross-section of the semiconductor acceleration sensor according to the third embodiment.

FIG. 7 shows the semiconductor acceleration sensor with the sealing resin removed, and FIG. 8 shows a cross-section along the line D-D in FIG. 7.

Furthermore, those elements which are the same as in embodiment 1 and embodiment 2 are given the same reference numerals and description thereof is omitted.

The semiconductor acceleration sensor 1 of the present embodiment, as shown in FIG. 7 and FIG. 8, comprises a laminate chip consisting of the same control chip 20 and sensor chip 9 as in embodiment 2, bonded together by vacuum pressure bonding, but differs in the following points.

In FIG. 8, reference numeral 35 indicates a glass plate acting as a rear plate which is bonded to the rear surface 9b of the support section 11 of the sensor chip 9 by anodic bonding or similar, the glass plate 35 having a rear surface 35b which is bonded to the base of the cavity 4 of the case 2 by the adhesive layer 25. In this manner the laminate chip is secured to the case 2 via the glass plate 35.

Reference numeral 36 indicates a sealing layer, formed by heat-hardening a sealing resin, for example a nonconductive thermosetting epoxy resin, injected into the space between the cavity 4 of the case 2 and the external surfaces of the laminate chip. The sealing layer 36 has the function of protecting the wires 23 from external forces during installation of the semiconductor acceleration sensor 1, and protecting the laminate chip from moisture and other external factors.

The height of the frame shaped protrusion 18 from the pad formation surface 9a in the present embodiment is set such that a gap Sa is formed between the top surface of the flexible sections 12 and the rear surface 20b of the control chip 20 as in the second embodiment, and a similar gap Sc is formed between the top surface of the glass plate 35 and the bottom surface of the weight section 13 by such methods as raising the height of the support section 11 as shown in FIG. 8.

The gap Sa and gap Sc of the present embodiment are each formed to a thickness of approximately 10 to 20 μm.

The following describes a method of manufacturing a semiconductor acceleration sensor 1 with the configuration described above.

### (Step 1)

In the same manner as in step 2 of embodiment 2, a semiconductor wafer formed with sensor chips 9 is bonded to the rear surface of a semiconductor wafer formed with control chips 20 comprising through holes 31, using vacuum pressure bonding. Subsequently, the glass plate 35 is bonded using anodic bonding to the rear surface of the semiconductor wafer formed with the sensor chips 9, and the two joined semiconductor wafers are processed into individual chips together with the glass plate 35. As a result, a laminate chip is formed wherein the frame shaped protrusion 19, of the sensor chip 9 comprising the glass plate 35 bonded to the rear surface 9b, is bonded to the rear surface 20b of the control chip 20.

Furthermore, in the same manner as in step 1 of embodiment 1, the case 2 is formed.

### (Step 2)

In the same manner as in step 1 of embodiment 1, a rear surface 35a of the glass plate 35 bonded to the rear surface 9b of the sensor chip 9 is affixed to the central part of the base of the cavity 4 of the case 2, and the laminate chip, consisting of the control chip 20 bonded on top of the sensor chip 9 to which the glass plate 35 is bonded, is bonded to the base of the cavity 4 by means of the adhesive layer 25.

(Step 3)

In the same manner as in step 4 of embodiment 1, a wire bonder is used to electrically connect the internal terminals 7 to the connection terminals 21, and the connection terminals 21 to the pads 15, by means of the wires 23.

### (Step 4)

After the wire bonding process is completed, a sealing resin is injected between the cavity 4 of the case 2 and the external surface of the laminate chip and heat-hardened to form the sealing layer 36 which seals in an object, such as the laminate chip consisting of the control chip 20 bonded on top of the sensor chip 9, inside the cavity 4 of the case 2.

At this time, because the movable parts of the sensor chip 9 of the present embodiment are hermetically sealed by the control chip 20 and the glass plate 35, the sealing resin does not infiltrate the movable parts of the sensor chip 9.

Furthermore, because the laminate chip or other object is sealed in the cavity 4 of the case 2 by the sealing layer 36, the step of bonding the cover 27 can be omitted.

In this manner the semiconductor acceleration sensor 1 of the embodiment shown in FIG. 7 and FIG. 8 is manufactured. In this semiconductor acceleration sensor 1, the frame shaped protrusion 15 formed on the pad formation surface 9a of the support section 11 of the sensor chip 9 is bonded by vacuum pressure bonding to the rear surface 20b of the control chip 20, and the rear surface 9b of the sensor chip 9 is bonded by anodic bonding to the glass plate 35. Consequently, the rigidity of the support section 11 of the sensor chip 9 can be further enhanced, yielding an improvement in measurement sensitivity and a reduction in temperature drift.

Furthermore, because the movable part 12 of the sensor chip 9 in the present embodiment is hermetically sealed by the control chip 20 and the glass plate 35, water can be prevented from infiltrating the piezo elements 10 during the manufacturing process, the laminate chip can be sealed using a sealing resin which is more economical than using the cover 27, and the height of the semiconductor acceleration sensor 1 can be reduced due to the omission of the cover 27.

In addition, in the semiconductor acceleration sensor 1 of the present embodiment, in the same manner as embodiment 2, because the predetermined gaps Sa and Sc are formed above and below the movable parts of the sensor chip 9 respectively, damage to the flexible sections 12 during acceleration measurement can be prevented.

Because the present embodiment otherwise works in the same way as embodiment 2, further description is omitted.

As described above, in the present embodiment, in addition to providing the same effects as the second embodiment, by bonding a glass plate to the rear surface of the sensor chip, the rigidity of the support section of the sensor chip is further enhanced, and the effects of improving measurement sensitivity and reducing temperature drift are also enhanced. Furthermore, because the movable parts of the sensor chip can be hermetically sealed by the control chip and the glass plate, moisture can be prevented from infiltrating the piezo elements during the manufacturing process, and the laminate chip can be sealed using a sealing resin, and by omitting the cover the height of the semiconductor acceleration sensor can be reduced.

Moreover, in the present embodiment, the rear plate was described as a glass plate, but the rear plate to be bonded to the rear surface of the support section is not limited thereto, and a silicon or metal plate or the like may be used instead.

### EMBODIMENT 4

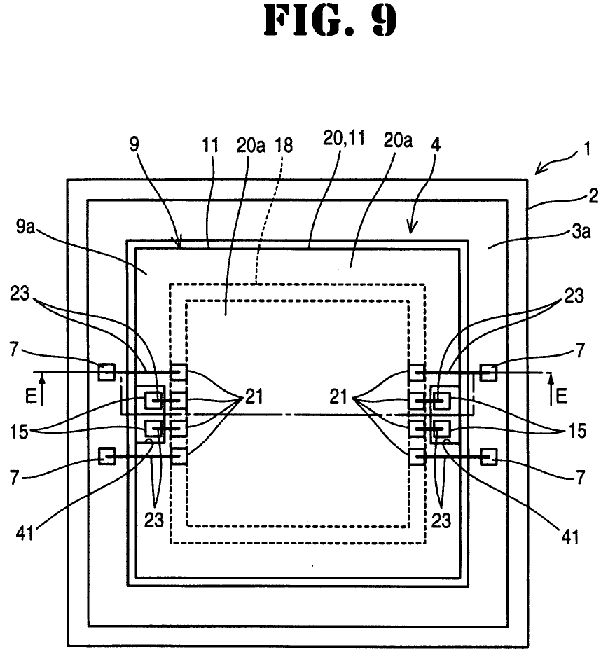

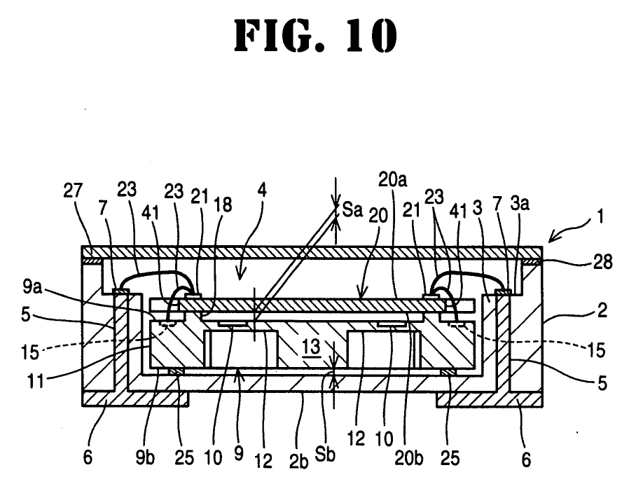

FIG. 9 is an explanatory diagram showing the top surface of a semiconductor acceleration sensor according to a fourth embodiment, and FIG. 10 is an explanatory diagram showing a cross-section of the semiconductor acceleration sensor according to the fourth embodiment.

FIG. 9 shows a state in which the cover is removed, and FIG. 10 shows a cross-section along the line E-E in FIG. 9.

Furthermore, those elements which are the same as in embodiment 1 are given the same reference numerals and description thereof is omitted.

As shown in FIG. 9 and FIG. 10, the control chip 20 of the present embodiment has the same planar shape as the sensor chip 9, and in the areas that cover the pads 15 of the sensor chip 9, notches 41 are formed so that the pads 15 are visible from the terminal formation surface 20a side.

Furthermore, the bonding of the frame shaped protrusion 18 of the sensor chip 9 to the rear surface 20b of the control chip 20 is performed using vacuum pressure bonding.

The height of the frame shaped protrusion 18 from the pad formation surface 9a in the present embodiment is set such that a gap Sa is formed between the top surface of the flexible section 12 and the rear surface 20b of the control chip 20 as in the second embodiment, and the thickness of the adhesive layer 25 is set such that a gap Sb is formed between the bottom surface of the weight section 13 and the base of the cavity 4.

The thickness of the adhesive layer 25 and the height of the frame shaped protrusion 18 in the present embodiment are each set to approximately 10 to 20 μm.

The following describes a method of manufacturing a semiconductor acceleration sensor 1 with the configuration described above.

### (Step 1)

A semiconductor wafer is prepared formed with a plurality of control chips 20 in which adjacent through holes 31 from embodiment 2 are combined into large through holes in areas that include the pads 15 from a pair of adjacent sensor chips 9. Furthermore, a semiconductor wafer is prepared formed with a plurality of sensor chips 9 provided with frame shaped protrusions 18. The frame shaped protrusions 18 of the semiconductor wafer formed with the sensor chips 9 are bonded to the rear surface of the semiconductor wafer formed with the control chips 20 by vacuum pressure bonding after each set of pads 15 from a pair of adjacent sensor chips 9 is aligned with the corresponding large through hole. Subsequently, the two joined semiconductor wafers are processed together into individual laminate chips in which the frame shaped protrusion 19 of the sensor chip 9 is bonded to the rear surface 20b of the control chip 20.

At this time, the large through holes of the semiconductor wafer formed with the control chips 20 are segmented, thereby forming in the control chips 20 the notches 41 that allow the pads 15 of the sensor chip 9 to be visible from the terminal formation surface 20a side.

Furthermore, a case 2 is formed in the same manner as step 1 in embodiment 1.

### (Step 2)

In the same manner as in step 1 of the first embodiment, the rear surface 9b of the sensor chip 9 of the laminate chip is affixed to the center of the base of the cavity 4 of the case 2, and the laminate chip consisting of the control chip 20 bonded on top of the sensor chip 9 is bonded to the base of the cavity 4 by the adhesive layer 25.

### (Step 3)

In the same manner as in step 4 of embodiment 1, a wire bonder is used to electrically connect the internal terminals 7 to the connection terminals 21, and the connection terminals 21 to the pads 15, by means of the wires 23.

### (Step 4)

After the wire bonding process is completed, in the same manner as in step 5 of embodiment 1, the cover 27 is bonded to the case 2, forming a space that seals in an object such as the laminate chip consisting of the control chip 20 bonded on top of the sensor chip 9.

In this manner the semiconductor acceleration sensor 1 of the embodiment shown in FIG. 9 and FIG. 10 is manufactured. In this semiconductor acceleration sensor 1, because the frame shaped protrusion 15 formed on the pad formation surface 9a of the support section 11 of the sensor chip 9 is bonded to the rear surface 20b of the control chip 20 using vacuum pressure bonding, in the same manner as the first embodiment, the rigidity of the support section 11 of the sensor chip 9 is enhanced, yielding an improvement in measurement sensitivity and a reduction in temperature drift.

Furthermore, because the control chip 20 is laminated onto a sensor chip 9 of similar size, in the same manner as embodiment 1, the laminate chip can occupy the same area as the planar shape of the sensor chip 9 alone, and the package size of the semiconductor acceleration sensor 1 can be reduced. Furthermore, this also facilitates higher integration of control chips 20 that have a large number of connection terminals 21.

In addition, in the semiconductor wafer manufacturing process, because a semiconductor wafer formed with a plurality of control chips 20 comprising large through holes is bonded to a semiconductor wafer formed with sensor chips 9 in such a manner that the location of each large through hole corresponds to the location of the pads 15 of a pair of adjacent sensor chips 9, electrical testing of the sensor chip 9 and the control chip 20 can be performed simultaneously, which simplifies the testing process of the sensor chip 9 and the control chip 20 during manufacture. Furthermore, in the semiconductor wafer manufacturing process, laminate chips consisting of a control chip 20 with notches 41 formed by the segmentation of the large through holes that occurs during processing of the wafers into individual chips, bonded onto a sensor chip 9, can be prepared in advance, which simplifies the assembly process of the semiconductor acceleration sensor 1 and reduces the assembly cost.

In addition, in the semiconductor acceleration sensor 1 of the present embodiment, the height of the frame shaped protrusion 18 bonded to the rear surface 20b of the control chip 20 by vacuum pressure bonding, and the thickness of the adhesive layer 25 which bonds the rear surface 9b of the sensor chip 9 to the base of the cavity 4 form predetermined gaps Sa and Sb above and below the movable parts of the sensor chip 9 consisting of the weight section 13 and the flexible sections 12. Consequently, the degree of flexure of the flexible sections 12 can be restricted, and damage to the flexible section 12 during acceleration measurement can be prevented. Furthermore, because in the manufacturing process of the semiconductor wafer a laminate chip is formed in which the control chip 20 covers the flexible sections 12 of the sensor chip 9, the flexible sections 12 are protected from external forces resulting from collision with other parts during transportation of the laminate chip or installation into the case 2, and damage can be prevented.

In addition, in the wire bonding process described in step 3, because the control chip 20 of the present embodiment which is bonded on top of the sensor chip 9 is formed such that the pads 15 of the sensor chip 9 are visible from the terminal formation surface 20a side through the notches 41, connections can be easily established between the pads 15 of the sensor chip 9 and the connection terminals 21 of the control chip 20 by means of the wire 23. Furthermore, in the same manner as in embodiment 1, the positioning of the connection terminals 21 of the control chip 20 above the frame shaped protrusion 18 of the sensor chip 9 has the effect of preventing deformation of the control chip 20 and reducing impact on the sensor chip 9.

As described above, in the present embodiment, in addition to realizing the same effects as the first embodiment, by forming notches in the control chip through which the pads of the sensor chip are visible, a large through hole is provided in the semiconductor wafer formed with the control chips, and this can be bonded onto the semiconductor wafer formed with the sensor chips during the semiconductor wafer manufacturing process. Therefore, electrical testing of the sensor chips and control chips can be performed simultaneously, which simplifies the testing process during manufacture of the sensor chips and the control chips. Furthermore, a laminate chip that contains a control chip provided with notches can be formed in advance in the semiconductor wafer manufacturing process, which simplifies the assembly process of the semiconductor acceleration sensor.

### EMBODIMENT 5

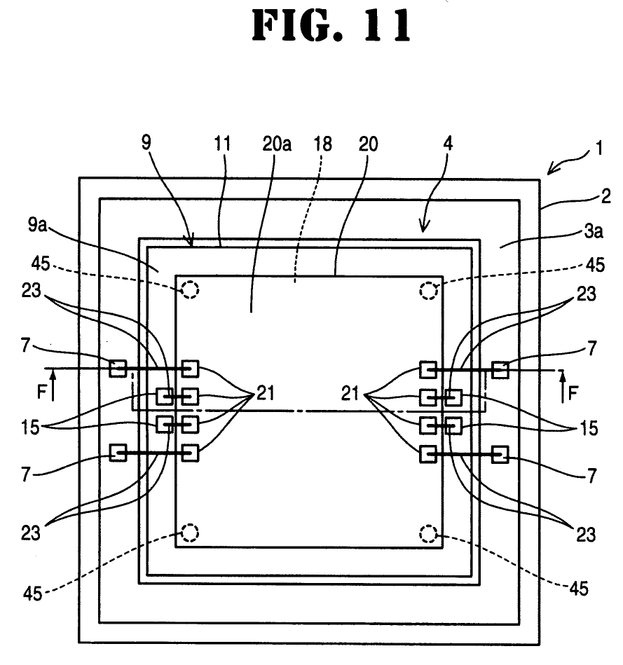

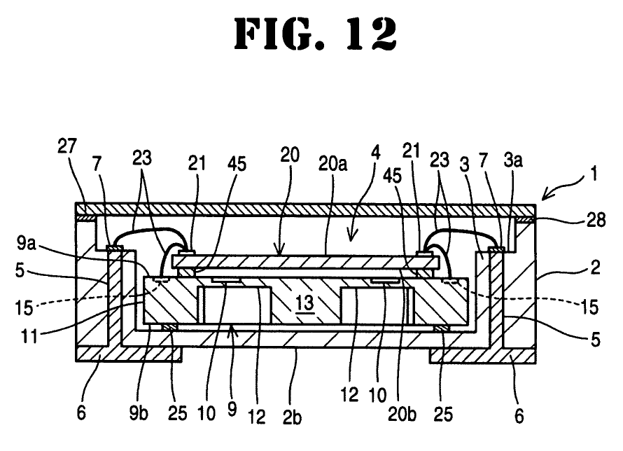

FIG. 11 is an explanatory diagram showing the top surface of a semiconductor acceleration sensor according to a fifth embodiment, and FIG. 12 is an explanatory diagram showing a cross-section of the semiconductor acceleration sensor according to the fifth embodiment.

FIG. 11 shows a state in which the cover is removed, and FIG. 12 shows a cross-section along the line F-F in FIG. 11.

Furthermore, those elements which are the same as in embodiment 1 are given the same reference numerals and description thereof is omitted.

As shown in FIG. 11 and FIG. 12, the control chip 20 of the present embodiment has a miniaturized planar shape as in the first embodiment, and is formed such that the pads 15 of the sensor chip 9 are visible from the terminal formation surface 20a side.

Furthermore, a frame shaped protrusion 18 is not provided on the pad formation surface 9a of the sensor chip 9 in the present embodiment, and the bonding with the rear surface 20b of the control chip 20 is performed using an adhesive 45 deposited on the pad formation surface 9a at positions corresponding to the four corners of the control chip 20.

The adhesive layer 25 in the present embodiment is formed to a thickness of approximately 10 to 20 μm.

The following describes a method of manufacturing a semiconductor acceleration sensor 1 with the configuration described above.

### (Step 1)

The sensor chip 9 is formed by processing a semiconductor wafer formed with a plurality of sensor chips 9 into individual chips, and the control chip 20 is formed by processing a semiconductor wafer formed with a plurality of control chips 20 into individual chips.

Furthermore, a case 2 is formed in the same manner as in step 1 of embodiment 1.

### (Step 2)

In the same manner as in step 1 of embodiment 1, the rear surface 9b of the sensor chip 9 is affixed to the center of the base of the cavity 4 of the case 2 by the adhesive layer 25.

### (Step 3)

After the sensor chip 9 is bonded to the case 2, the adhesive 45 is deposited onto the pad formation surface 9a of the sensor chip 9 at positions corresponding to the four corners of the control chip 20, and the control chip 20 is positioned and the rear surface 20b thereof is affixed to the pad formation surface 9a of the sensor chip 9, thereby forming a laminate chip consisting of a control chip 20 bonded on top of a sensor chip 9.

### (Step 4)

In the same manner as in step 4 of embodiment 1, a wire bonder is used to electrically connect the internal terminals 7 to the connection terminals 21, and the connection terminals 21 to the pads 15, by means of the wire 23.

### (Step 5)

After the wire bonding process is completed, in the same manner as in step 5 of embodiment 1, the cover 27 is bonded to the case 2, forming a space that seals in the laminate chip consisting of the control chip 20 bonded on top of the sensor chip 9.

In this manner, the semiconductor acceleration sensor 1 of the present embodiment shown in FIG. 11 and FIG. 12 is manufactured. In this semiconductor acceleration sensor 1, the pad formation surface 9a of the support section 11 of the sensor chip 9 is bonded to the rear surface 20b of the control chip 20 by the adhesive 45. Consequently, the rigidity of the support section 11 which supports movable parts such as the flexible sections 12 is enhanced, allowing the acceleration applied to the sensor chip 9 to be measured with greater sensitivity. Furthermore, bending or the like of the support section 11 that occurs with variation in the temperature within the package can be prevented, thereby suppressing the effect of temperature drift on the pressure signal of the sensor chip 9.

Furthermore, in the same manner as in embodiment 1, because a control chip 20 which can be easily miniaturized is bonded on top of a sensor chip 9 whose parameters, particularly size, are determined based on dynamic parameters, in the same manner as in embodiment 1, the laminate chip can occupy the same area as the planar shape of the sensor chip 9 when installed, which allows the package size of the semiconductor acceleration sensor 1 to be reduced. Furthermore, further miniaturization and higher integration of control chips 20 that contain a large number of connection terminals 21 can easily be achieved.

In addition, because there is no need to form a frame shaped protrusion on the sensor chip 9, the production costs of the sensor chip 9 can be reduced.

In addition, in the wire bonding process in step 4, because the control chip 20 of the present embodiment is miniaturized as in embodiment 1, the pads 15 of the sensor chip 9 can be easily connected to the connection terminals 21 of the control chip 20 using the wires 23.

As described above, in the present embodiment, the rear surface of a control chip with a planar shape that allows the pads of the sensor chip to be visible from the terminal formation surface side is bonded by an adhesive to the pad formation surface of a sensor chip which has a plurality of pads formed around its edges. Consequently, the rigidity of the support section which supports movable parts such as the flexible sections is enhanced, allowing the acceleration applied to the sensor chip to be measured with greater sensitivity. Furthermore, the area occupied by the sensor chip and the control chip when installed can be the same as the area of the planar shape of the sensor chip, which allows the package size of the semiconductor acceleration sensor to be reduced further.

In the various embodiments described above, the pads of the sensor chip are provided on two opposing sides of the support section of the sensor chip, but the placement of the pads of the sensor chip is not limited to this configuration, and pads may be positioned on all sides of the support section, or on three sides. In this case, the through holes and notches are to be provided at locations corresponding to the pads of the sensor chip.

Furthermore, the various elements described in the embodiments such as the methods used to bond the sensor chip and control chip together, and the bonding of the glass plate, are not restricted to the planar shape of the sensor chip and control chip shown in the embodiments, and may be used in appropriate combinations.

What is claimed is:

1. A semiconductor acceleration sensor comprising:
a sensor chip having a pad formation surface around whose edge are formed a plurality of pads, and in which a rectangular frame shaped protrusion is formed on an area of said pad formation surface on a center side of said pads; and
a control chip which has a terminal formation surface on which connection terminals are formed, and has a planar shape such that the pad of said sensor chip is visible from said terminal formation surface side,
wherein an opposite surface of said control chip to the terminal formation surface is bonded to the frame shaped protrusion of said sensor chip.

2. A semiconductor acceleration sensor according to claim 1, wherein connection terminals of said control chip are formed on said frame shape protrusion.

3. A semiconductor acceleration sensor according to claim 1, wherein said control chip has a planar shape that is smaller than a rectangular shape inscribed in the pads of said sensor chip.

4. A semiconductor acceleration sensor according to claim 1, wherein said control chip has a through hole through which the pads of said sensor chip are visible.

5. A semiconductor acceleration sensor according to claim 1, wherein said control chip has a notch through which the pads of said sensor chip are visible.

6. A semiconductor acceleration sensor according to claim 1, wherein a rear plate is bonded to an opposite surface of said the sensor chip to the pad formation surface.

7. A semiconductor acceleration sensor comprising:
a sensor chip having a pad formation surface around whose edge are formed a plurality of pads; and
a control chip which has a terminal formation surface on which connection terminals are formed, and has a planar shape such that the pad of said sensor chip is visible from said terminal formation surface side,
wherein an opposite surface of said control chip to the terminal formation surface is bonded by an adhesive to the pad formation surface of said sensor chip.

8. A semiconductor acceleration sensor according to claim 7, wherein said control chip has a planar shape that is smaller than a rectangular shape inscribed in the pads of said sensor chip.

9. A semiconductor acceleration sensor according to claim 7, wherein said control chip has a through hole through which the pads of said sensor chip are visible.

10. A semiconductor acceleration sensor according to claim 7, wherein said control chip has a notch through which the pads of said sensor chip are visible.

11. A semiconductor acceleration sensor according to claim 7, wherein a rear plate is bonded to an opposite surface of said the sensor chip to the pad formation surface.
